(19) United States
(12) Patent Application Publication
(10) Pub. No.: US 2026/0134501 A1
(43) Pub. Date: May 14, 2026

(54) INSPECTION IMAGE STORING SYSTEM AND METHOD OF STORING INSPECTION IMAGES

(71) Applicant: MITSUBISHI ELECTRIC CORPORATION, Tokyo (JP)

(72) Inventors: Yohei HISADA, Tokyo (JP); Tatsuya NAGATANI, Tokyo (JP); Yuji ASANO, Tokyo (JP); Weihau LEE, Tokyo (JP)

(73) Assignee: MITSUBISHI ELECTRIC CORPORATION, Tokyo (JP)

(21) Appl. No.: 19/481,897

(22) PCT Filed: Nov. 22, 2023
(86) PCT No.: PCT/JP2023/041966

§ 371 Date: Nov. 6, 2025

(51) Int. Cl. G06T 1/60; G06T 9/00

(52) U.S. Cl. CPC G06T 1/60; G06T 9/00

(57) ABSTRACT

An image acquirer acquires inspection images. A compression manager selects an image compressor expected to compress an inspection image from image compressors, allocates the inspection image to the selected image compressor, and transmits the inspection image to the image compressor to which the inspection image is allocated. A storage stores compressed inspection images generated by compressing the inspection images by the plurality of image compressors. The image compressors are connected to the compression manager and the storage via a communication network, and compresses the inspection images transmitted by the compression manager.

### TECHNICAL FIELD

The present disclosure relates to an inspection image storing system and a method of storing inspection images.

### BACKGROUND ART

In recent years, systems are required to store all inspection images of manufactured products to ensure traceability of the manufactured products. Inspection images have large data sizes and must be compressed before storage to reduce the pressure on storage capacity. General lossless compression of images such as the portable network graphics (PNG) format, however, cannot be readily executed by a general-purpose central processing unit (CPU) in real time, because the processing load rises in accordance with an increase in the number of inspection images to be compressed or an increase in the compression ratio. In some techniques, such image compression is executed by a dedicated hardware, system, or the like in real time. For example, Patent Literature 1 discloses a technique in which a storage device rapidly and readily stores image data by compressing the image data input from a camera, providing information to the image data, and packing the image data in accordance with predetermined parameters, and transmitting the image data to an external storage device.

### CITATION LIST

### Patent Literature

Patent Literature 1: Unexamined Japanese Patent Application Publication No. 2013-164641

### SUMMARY OF INVENTION

### Technical Problem

As described above, existing techniques cause a single hardware component, a system for sequential processing, or the like to execute the processes from compression to storage of inspection images, and thus fail to ensure scalability of performance of compression and storage of inspection images.

An objective of the present disclosure, which has been accomplished in view of the above situations, is to provide an inspection image storing system and a method of storing inspection images that can ensure scalability of compression performance for inspection images.

### Solution to Problem

In order to achieve the above objective, an inspection image storing system according to the present disclosure includes: at least one image acquisition means to acquire inspection images; a plurality of image compression means to compress the inspection images; compression management means to select an image compression means expected to compress an inspection image from the plurality of image compression means, allocate the inspection image to the selected image compression means, and transmit the inspection image to the image compression means to which the inspection image is allocated; and at least one storage means to store compressed inspection images generated by compressing the inspection images by the plurality of image compression means. The plurality of image compression means is connected to the compression management means and the at least one storage means via a communication network, and compresses the inspection images transmitted by the compression management means.

### Advantageous Effects of Invention

The present disclosure provides an inspection image storing system and a method of storing inspection images that can ensure scalability of compression performance for inspection images.

### BRIEF DESCRIPTION OF DRAWINGS

FIG. 1 illustrates an inspection image storing system according to Embodiment 1;

FIG. 2 is a block diagram illustrating a hardware configuration of an information processing device according to the embodiment;

FIG. 3 illustrates an exemplary allocation of inspection images according to Embodiment 1;

FIG. 4 illustrates another exemplary allocation of inspection images according to Embodiment 1;

FIG. 5 illustrates an exemplary mode of managing a list of inspection images awaiting compression according to Embodiment 1;

FIG. 6 illustrates an inspection image storing system according to Embodiment 2;

FIG. 7 illustrates an inspection image storing system according to Embodiment 3;

FIG. 8 is a flowchart illustrating a storage destination designating process according to Embodiment 3;

FIG. 9 is an explanatory diagram for an exemplary switching of a storage destination according to Embodiment 3;

FIG. 10 is an explanatory diagram for another exemplary switching of a storage destination according to Embodiment 3;

FIG. 11 illustrates an inspection image storing system according to Embodiment 4; and

FIG. 12 illustrates an exemplary allocation of inspection images according to Embodiment 4.

### DESCRIPTION OF EMBODIMENTS

### Embodiment 1

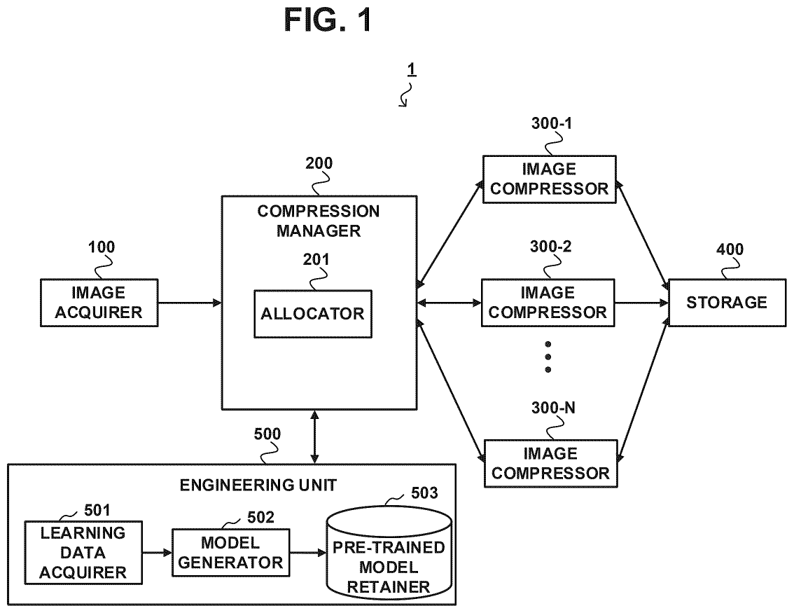

An inspection image storing system 1 according to Embodiment 1 is designed to store all inspection images. As illustrated in FIG. 1, the inspection image storing system 1 includes, as functional components, an image acquirer 100, a compression manager 200, image compressors 300-1 to 300-N (N is a natural number equal to or larger than 2), a storage 400, and an engineering unit 500. The image compressors 300-1 to 300-N are hereinafter collectively referred to as “image compressors 300” unless specifying a particular image compressor. The image acquirer 100, the compression manager 200, the image compressors 300, the storage 400, and the engineering unit 500 are implemented on separate information processing devices. The image compressors 300 are connected to the compression manager 200 and the storage 400 via a communication network, which is not illustrated. The compression manager 200 is connected to the image acquirer 100 and the engineering unit 500, via a communication network, which is not illustrated.

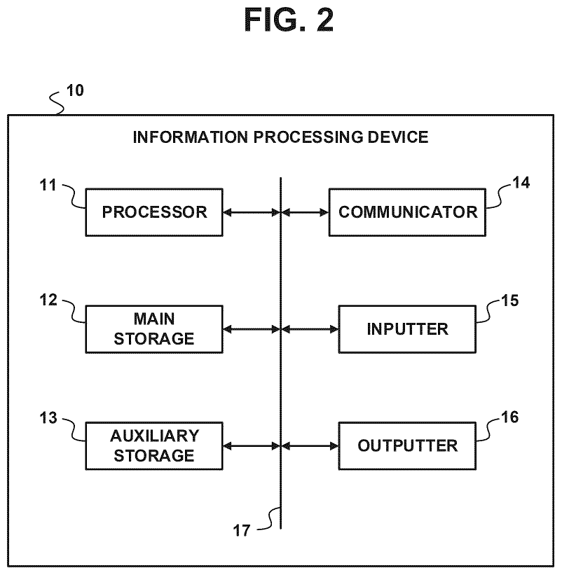

FIG. 2 illustrates an exemplary hardware configuration of an information processing device 10 that performs the functions of each of the image acquirer 100, the compression manager 200, the image compressors 300, the storage 400, and the engineering unit 500.

The information processing device 10 includes a processor 11 that executes various processes, a main storage 12 that serves as a work area of the processor 11, an auxiliary storage 13 that stores various types of data to be used in the processes in the processor 11, a communicator 14 for communication with external apparatuses, and an inputter 15 that acquires input information, and an outputter 16 that presents various types of information. The main storage 12, the auxiliary storage 13, the communicator 14, the inputter 15, and the outputter 16 are each connected to the processor 11 via buses 17.

The processor 11 includes a central processing unit (CPU). The processor 11 executes a program stored in the auxiliary storage 13 and thereby performs various functions of the information processing device 10.

The main storage 12 includes a random access memory (RAM). The main storage 12 receives a program loaded from the auxiliary storage 13. The main storage 12 serves as a work area of the processor 11.

The auxiliary storage 13 includes a non-volatile memory, such as electrically erasable programmable read-only memory (EEPROM). The auxiliary storage 13 stores the program and various types of data used in processes in the processor 11. The auxiliary storage 13 provides the processor 11 with data to be used by the processor 11 and stores data fed from the processor 11 under the instructions from the processor 11.

The communicator 14 includes a network interface circuit for communication with external apparatuses. The communicator 14 receives signals from external apparatuses and outputs data indicated by the signals to the processor 11. The communicator 14 also transmits signals indicating the data output from the processor 11 to external apparatuses.

The inputter 15 includes an input device, such as input key or pointing device, and a camera. The inputter 15 acquires information input by a user of the information processing device 10 and notifies the processor 11 of the acquired information. The inputter 15 also captures images and notifies the processor 11 of information on the captured images.

The outputter 16 includes an output device, such as liquid crystal display (LCD) or speaker. The outputter 16 may configure a touch screen integrated with the pointing device included in the inputter 15. The outputter 16 presents various types of information to the user under the instructions from the processor 11.

The information processing device 10 is an exemplary information processing device that performs the functions of each of the image acquirer 100, the compression manager 200, the image compressors 300, the storage 400, and the engineering unit 500. The information processing device 10 may exclude some of its components as appropriate, depending on the functions of the image acquirer 100, the compression manager 200, the image compressors 300, the storage 400, and the engineering unit 500.

The image acquirer 100 acquires inspection images. The image acquirer 100 is an example of image acquisition means.

Specifically, the image acquirer 100 acquires inspection images by controlling the capturing operation of a camera, and transmits the acquired inspection images to the compression manager 200. The image acquirer 100 includes a controller, such as programmable logic controller (PLC), for controlling the camera, and the camera connected to the controller. The controller outputs signals to the camera in accordance with a predetermined control algorithm. The camera then receives the signals, captures inspection images, and transmits the captured inspection images to the controller.

The control algorithm varies depending on a process of the production line subject to capturing of inspection images. In an exemplary process, the production line continuously transports a single elongated material without interruption to continuously process the elongated material. Examples of the elongated material include steel sheet, paper, film, or electrode sheet used to manufacture lithium-ion batteries. For this process, the controller has a control algorithm for transmitting signals that instruct the camera to capture inspection images at either constant time intervals or constant distance intervals. The controller outputs signals to the camera in accordance with this control algorithm to control the capturing operation. In another exemplary manufacturing process of mass-produced items, the production line transports a large number of manufactured items, such as manufactured products or parts in production. For this process, the controller is connected to a sensor, and has a control algorithm for transmitting signals that instruct the camera to capture an inspection image in response to every detection of a manufactured item by the sensor. The controller outputs signals to the camera in accordance with this control algorithm to control the capturing operation. The components, such as camera, controller, and sensor, may be integrated with each other.

The compression manager 200 selects an image compressor 300 expected to compress an inspection image from multiple image compressors 300, and allocates the inspection image to the selected image compressor 300. The compression manager 200 then transmits the inspection image to the image compressor 300 to which the inspection image is allocated. The compression manager 200 is an example of compression management means.

Specifically, the compression manager 200 includes an allocator 201, The allocator 201 selects an image compressor 300 expected to compress an inspection image from the image compressors 300, and allocates the inspection image to the selected image compressor 300. “To allocate an inspection image” means to determine the image compressor 300 to compress the inspection image acquired by the image acquirer 100.

The inspection image may be allocated by the allocator 201, for example, regardless of the load statuses of the image compressors 300, in accordance with the performance of the image compressors 300, or on the basis of the load statuses of the image compressors 300. The inspection image may be allocated by a procedure, other than these examples, set by a setter of the engineering unit 500, which is not illustrated.

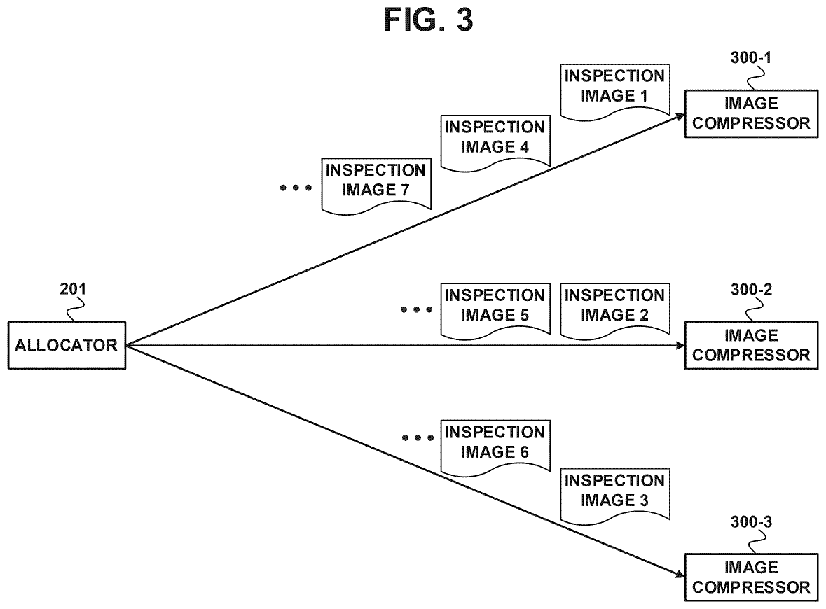

In an exemplary case where the engineering unit 500 sets the allocation procedure regardless of the load statuses of the image compressors 300, the allocator 201 sequentially allocates the acquired inspection images to the individual image compressors 300 one by one, so as to equalize the number of inspection images to be compressed by each image compressor 300, for example. FIG. 3 illustrates an exemplary allocation to ensure an equal number of compressed inspection images. In the example in FIG. 3, the inspection image storing system 1 includes three image compressors 300. Assuming that the inspection images are acquired by the image acquirer 100 in the order of an inspection image 1, an inspection image 2, . . . , and an inspection image M (M is a natural number equal to or larger than 3), the allocator 201 allocates the inspection image 1 to the image compressor 300-1, the inspection image 2 to the image compressor 300-2, and the inspection image 3 to the image compressor 300-3. After the allocation to the image compressor 300-3, the allocator 201 allocates an inspection image 4 and the following inspection images, in the order from the image compressor 300-1.

In another exemplary case where the engineering unit 500 sets the allocation procedure in accordance with the performance of the image compressors 300, the allocator 201 adjusts the distribution of the number of inspection images in accordance with the performance of the image compressors 300. The performance of the image compressors 300 are indicated by performance information stored in the auxiliary storage 13 of the compression manager 200, for example. The allocator 201 refers to this performance information, and determines the distribution depending on the performance indicated by the performance information.

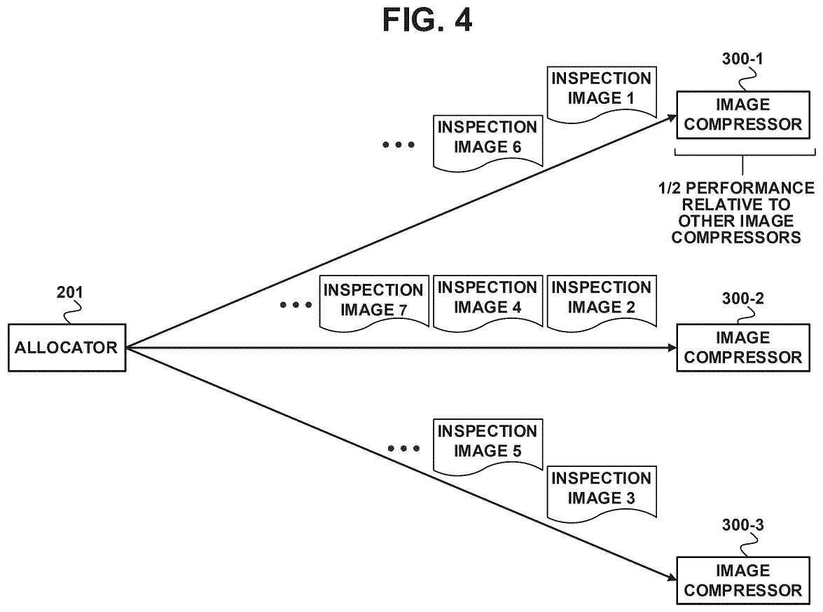

FIG. 4 illustrates another exemplary allocation to distribute different numbers of inspection images to three image compressors 300 in accordance with their performance. This example assumes the difference in performance between the image compressor 300-1 capable of compressing a single image in a certain period and the other image compressors 300-2 and 300-3 each capable of compressing two images in the same period. The allocator 201 allocates, after the allocation of the inspection image 3, the inspection image 4 to the image compressor 300-2, and an inspection image 5 to the image compressor 300-3. This allocation procedure can equalize the periods required for compression. When the image compressor 300-1 has sufficient performance and, at the allocation of the inspection image 4, has already completed the compression of the inspection image 1 and entered a waiting state, the allocator 201 may allocate the inspection image 4 to the image compressor 300-1.

In another exemplary case where the engineering unit 500 sets the allocation procedure based on the load statuses of the image compressors 300, the allocator 201 acquires information indicating the load statuses of the image compressors 300, and allocates inspection images acquired by the image acquirer 100 to the image compressors 300 on the basis of the load statuses indicated by the acquired information. The load status means the status of load on an image compressor 300 resulting from the compression.

For example, the allocator 201 acquires, online, the information indicating the load statuses of the image compressors 300 from the image compressors 300, and allocates an inspection image to the image compressor 300 with the lowest load resulting from compression, among the image compressors 300. The information indicating the load status indicates the total data volume or number of inspection images awaiting compression, or an expected compression period for inspection images awaiting compression, for example. The expected compression period is calculated by the allocator 201 in view of factors, such as performance of the image compressor 300, data sizes of the inspection images, compression procedure, and compression ratio. The information indicating the load status may also be calculated by the allocator 201, in view of the past achievements by the image compressor 300. The allocator 201 allocates an inspection image to the image compressor 300 with the lowest load to equalize the load statues of the image compressors 300. The allocator 201 can thus allocate inspection images to multiple image compressors 300. After the allocation of the inspection image to the image compressor 300 by the allocator 201, the compression manager 200 transmits the inspection image to the image compressor 300 to which the inspection image is allocated.

The image compressor 300 then compresses the inspection image received from the compression manager 200. The image compressor 300 then transmits a compressed inspection image generated by compressing the inspection image, to the storage 400. The image compressor 300 is an example of image compression means.

The number of image compressors 300 connected in parallel to the compression manager 200 can be flexibly varied, since the image compressors 300 are connected to the compression manager 200 via the communication network. The image compressors 300 connected in parallel are not required to have uniform hardware and software and may have different types of hardware and software. Each of the image compressors 300 manages a list of inspection images awaiting compression in a queue structure. The list of inspection images awaiting compression has a data structure for storing inspection images to be compressed. When the image compressor 300 receives an inspection image from the compression manager 200, the image compressor 300 introduces the received inspection image to the list of inspection images awaiting compression. The image compressor 300 extracts inspection images from the list of inspection images awaiting compression in the order of reception, and compresses the extracted inspection images.

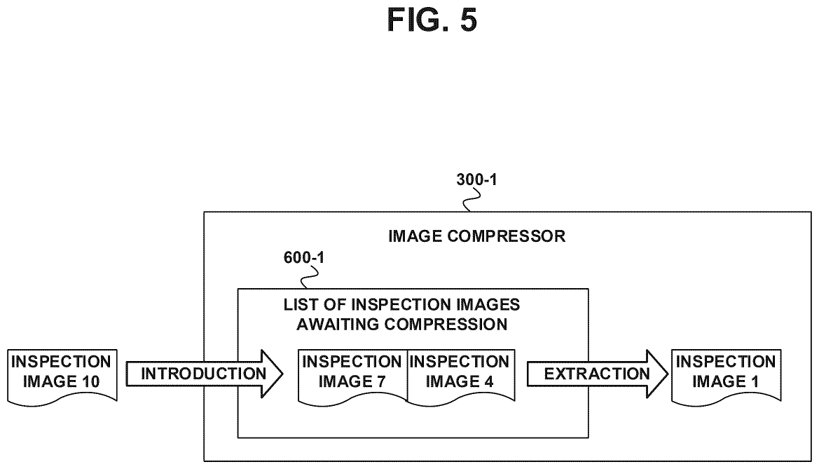

FIG. 5 illustrates an example in which the image compressor 300-1 manages the list of inspection images awaiting compression. The image compressor 300-1 retains a list 600-1 of inspection images awaiting compression. The list 600-1 of inspection images awaiting compression contains inspection images 1, 4, and 7. The image compressor 300-1 extracts the inspection image 1 from the list 600-1 of inspection images awaiting compression, and compresses the inspection image 1. After completion of compression of the inspection image 1, the image compressor 300-1 transmits the compressed inspection image 1 generated by compressing the inspection image 1, to the storage 400. The image compressor 300-1 then extracts the inspection image 4 from the list 600-1 of inspection images awaiting compression, and compresses the inspection image 4. When receiving another inspection image 10 from the compression manager 200, the image compressor 300-1 introduces the inspection image 10 to the list 600-1 of inspection images awaiting compression, as the inspection image to be compressed subsequently to the inspection image 7. The image compressor 300 thus compresses inspection images while managing the list of inspection images awaiting compression. In the case of no inspection image contained in the list of inspection images awaiting compression, the image compressor 300 compresses the received inspection image immediately after reception.

The storage 400 stores compressed inspection images compressed by the image compressor 300. The storage 400 is preferably implemented by a non-transitory recording medium capable of storing a large volume of data for a long period at low cost. A typical example of the storage 400 is a linear tape-open (LTO) tape. The storage 400 is an example of storage means.

The order of storage of compressed inspection images by the storage 400 may be identical to the order of reception of the compressed inspection images from the image compressors 300, or the chronological order of acquisition of the inspection images by the image acquirer 100. Storing inspection images in the order of reception can maintain a low load on the storage 400, because this mode eliminates the need for order control by the storage 400. In another example in which the storage 400 stores inspection images in the chronological order, the image acquirer 100 acquires an inspection image, provides the inspection image with chronological information, and then transmits the inspection image accompanying the chronological information to the compression manager 200. The compression manager 200 transfers the inspection image accompanying the chronological information to the image compressor 300. The image compressor 300 provides the compressed inspection image with the chronological information and transmits the compressed inspection image to the storage 400. The storage 400 aligns the compressed inspection images in the chronological order on the basis of the chronological information, and stores the aligned compressed inspection images in the chronological order. The chronological information indicates times of acquisition of inspection images, or the numbers indicating the order of acquisition of inspection images, for example. Storing the compressed inspection images in the chronological order leads to efficient analysis of the inspection images. For example, such efficient analysis is achieved when the analysis is directed to temporal variations in the elongated material, or to the timing of appearance of nonconforming items among mass-produced items in a quality inspection.

The engineering unit 500 estimates a performance required for the image compressors 300 before the inspection image storing system 1 executes the operation from acquisition of inspection images until storage of the inspection images, and acquires and presents information on the statuses of compression online during the operation of the inspection image storing system 1. The engineering unit 500 has functions implemented by an engineering tool.

The following describes the steps of estimating a performance required for the image compressors 300 before the operation. First, a user of the inspection image storing system 1 inputs, into the engineering unit 500, compression process information on factors affecting a compression period. The compression process information indicates data sizes of inspection images, a compression procedure containing parameters, a compression ratio, a variation of inspection images during the operation, and a frequency of acquisition of inspection images by the image acquirer 100, for example. The variation of inspection images during the operation means a variation of inspection images caused by different part lots, changes in external light, or the like, for example. The engineering unit 500 then calculates a compression period on the basis of the compression process information, and outputs estimated performance of the image compressors 300, specifically, hardware specifications of the image compressors 300 capable of stockless compression of inspection images for the calculated compression period.

The suggested output formats may be a format of commercially available hardware components, a format of detailed specifications containing a clock frequency, or both of them. In the case of suggesting commercially available hardware components, the engineering unit 500 suggests multiple examples. The engineering unit 500 then acquires information indicating the performance of the image compressors 300 connected to the compression manager 200, and determines whether the image compressors 300 satisfy the required performance through comparison with the estimated performance. When determining that the image compressors 300 fail to satisfy the required performance, the engineering unit 500 may output hardware specifications necessary to satisfy the required performance. The suggested output format may be a format of commercially available hardware components, a format of detailed specifications containing a clock frequency, or both of them.

The engineering unit 500 may output compression process information indicating a newly suggested compression algorithm including a compression procedure containing parameters and a compression ratio, other than outputting hardware specifications.

Specifically, the engineering unit 500 includes a learning data acquirer 501 that acquires learning data, a model generator 502 that generates a pre-trained model inferring a compression algorithm for the image compressors 300 from learning data, and a pre-trained model retainer 503 that retains the pre-trained model.

For example, the learning data acquirer 501 acquires, as learning data, information on the performance of the image compressors 300, information on compression algorithms used by the image compressors 300, and information on inspection images. The information on the performance of the image compressor 300 indicates a processing speed for a single inspection image, information affecting the processing speed, or a usage rate of hardware resources, for example. Examples of the information affecting the processing speed include hardware specifications, such as clock frequency and cache architecture, and an efficiency of image processing software. The information on a compression algorithm used by the image compressor 300 indicates a compression procedure containing parameters or a compression ratio, for example. The information on inspection images indicates data sizes of the inspection images, or a variation of the inspection images during the operation, for example.

The engineering unit 500 acquires the information on the performance of the connected image compressors 300, as the information is automatically transmitted to the engineering unit 500 via the compression manager 200 after activation of the image compressors 300, or input by the user directly to the engineering unit 500.

The model generator 502 generates a pre-trained model that receives input of the information on the performance of the image compressors 300 and the information on inspection images and outputs a compression algorithm containing a compression procedure containing parameters and a compression ratio. The model generator 502 then causes the generated pre-trained model to be stored into the pre-trained model retainer 503. The model generator 502 may use a known learning algorithm, such as supervised learning algorithm, unsupervised learning algorithm, or reinforcement learning algorithm.

The engineering unit 500 thus suggests a compression algorithm for the image compressors 300 using the pre-trained model generated through machine learning. The engineering unit 500 may suggest a compression algorithm at the activation of the system, or adjust the compression procedure or the compression ratio in accordance with the suggested compression algorithm, for example.

Alternatively, the engineering unit 500 may suggest, as the number of image compressors 300 required in the inspection image storing system 1, the number calculated based on Expression 1 below. The required performance in Expression 1 means the number of inspection images required to be compressed per second in the inspection image storing system 1.

$$The required performance ( the number of images per second ) / the efficiency of each image compressor 300 ( the number of images per second ) = the number of image compressors 300. \qquad Expression 1$$

The engineering unit 500 acquires information on the statuses of the image compressors 300 via the compression manager 200 and outputs the acquired information, and can thus check for the statuses of compression online. The status of an image compressor 300 means the number or the total data volume of stocked inspection images, for example. The user may refer to the statuses of the image compressors 300, and add another image compressor 300 in the case of insufficient performance or may remove any of the existing image compressors 300 for replacement even during the operation. In order to add another image compressor 300, the user connects the additional image compressor 300 to the communication network, sets the additional image compressor 300 as an allocation destination at the engineering unit 500, and thus allows the allocator 201 to recognize the additional image compressor 300 as an allocation destination. In order to remove any of the existing image compressors 300, the user first deletes the retiring image compressor 300 from the allocation destinations at the engineering unit 500, and thus allows the allocator 201 to exclude the retiring image compressor 300 from the allocation destinations. The retiring image compressor 300 then compresses all the stocked inspection images and transmits the compressed inspection images to the storage 400. The user confirms the completion of compression of all the inspection images and transmission of the compressed inspection images at the engineering unit 500, and then disconnects the retiring image compressor 300 from the communication network.

The system according to this embodiment includes the image compressors connected via a network and can thus flexibly change the number of image compressors connected in parallel and ensure the scalability of compression performance. The image compressors may have different types of hardware and software and achieve desired performance using various types of resources.

The inspection image storing system according to the embodiment includes the engineering unit and can thus readily perform tuning and setting of the compression performance of the system before and during the operation.

### Embodiment 2

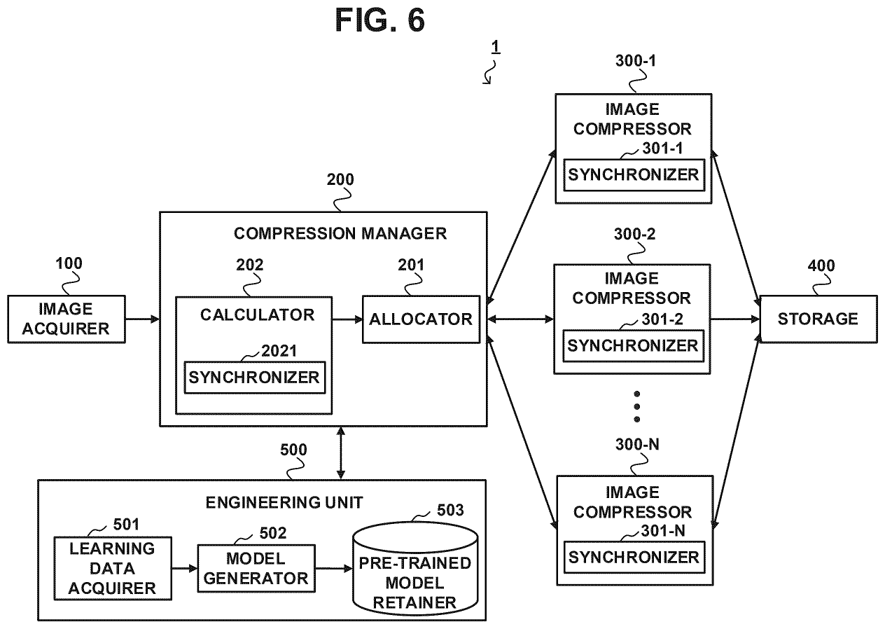

An inspection image storing system 1 according to Embodiment 2 has a function of controlling the timings of transmitting compressed inspection images from the image compressors 300 to the storage 400. As illustrated in FIG. 6, the inspection image storing system 1 includes, as functional components, an image acquirer 100, a compression manager 200, image compressors 300-1 to 300-N, a storage 400, and an engineering unit 500. The image compressors 300-1 to 300-N respectively include synchronizers 301-1 to 301-N for time synchronization with the compression manager 200. The synchronizers 301-1 to 301-N are hereinafter collectively referred to as “synchronizers 301” unless specifying a particular synchronizer. The image acquirer 100 and the storage 400 in Embodiment 2 have the same functions as those in Embodiment 1.

The compression manager 200 includes an allocator 201 that allocates inspection images to the image compressors 300, and a calculator 202 that calculates scheduled transmission times of transmitting compressed inspection images from the image compressors 300 to the storage 400. The calculator 202 further includes a synchronizer 2021 for time synchronization with the image compressors 300.

The time synchronization is performed by, for example, the synchronizer 2021 and the synchronizers 301 acquiring time information from a time information server on the communication network. The time synchronization reflects the time difference resulting from variations in transmission times across different paths in the communication network. The time synchronization needs to be highly accurate in a manufacturing environment. Such highly accurate time synchronization, however, cannot be realized due to a deviation of time generated by a time or the like necessary for transmission of time information via the communication network, for example. The time synchronization is thus required to reflect such a deviation resulting from transmission.

When the compression manager 200 receives an inspection image from the image acquirer 100, the calculator 202 calculates, for the received inspection image, a scheduled transmission time of transmitting a compressed inspection image corresponding to the received inspection image from the image compressor 300 to the storage 400, using the time synchronized by the synchronizer 2021 with the synchronizers 301.

Specifically, the calculator 202 first calculates an expected compression period required to compress a single inspection image. The expected compression period is calculated based on information including performance of the image compressors 300, data sizes of the inspection images, compression procedure, and compression ratio. The calculator 202 calculates expected compression periods for the individual image compressors 300, and then calculates a scheduled transmission time using the maximum expected period tE among the calculated expected compression periods and a margin period tG set by the user. For example, the compression manager 200 sequentially receives the inspection image 1, the inspection image 2, . . . , and the inspection image M from the image acquirer 100, and retains the times of reception of the inspection image 1, the inspection image 2, . . . , and the inspection image M respectively as reception times t1, t2, . . . , and tM. In this example, the calculator 202 obtains, for the inspection image 1, a scheduled transmission time T1 (=t1+tE+tG) of the inspection image 1 by calculating the sum of the reception time t1, the maximum expected period tE, and the margin period tG. Also, the calculator 202 obtains, for the inspection image 2, . . . , and the inspection image M, a scheduled transmission time T2 (=t2+tE+tG), . . . , and a scheduled transmission time TM (=tM+tE+tG) of the inspection image 1 by calculating the sum of the reception time t2, . . . , or tM, the maximum expected period tE, and the margin period tG. The maximum expected period tE varies depending on the conditions, such as data sizes of inspection images. If the margin period tG is constant, for example, the calculated scheduled transmission time T2 of the inspection image 2 may precede the calculated scheduled transmission time T1 of the inspection image 1. In such a case, the calculator 202 adjusts the margin period tG to obtain scheduled transmission times of the inspection image 1, the inspection image 2, . . . , and the inspection image M such that the scheduled transmission times are in the order identical to the chronological order of acquisition by the image acquirer 100. The scheduled transmission times are thus calculated such that compressed inspection images are transmitted in the chronological order of acquisition of the inspection images. The calculator 202 then provides the inspection images with information on the calculated scheduled transmission times.

The calculator 202 may calculate scheduled transmission times by inferring compression periods on the basis of data on previous compression periods. For example, the calculator 202 may calculate scheduled transmission times having sufficient intervals at first. After collecting a certain volume of data on compression periods, the calculator 202 may infer compression periods using a pre-trained model that infers a compression period generated through machine learning from the collected data, and calculate scheduled transmission times using the inferred compression periods as the expected compression periods. Alternatively, the calculator 202 may calculate scheduled transmission times using a pre-trained model that infers a scheduled transmission time generated through machine learning from the data collected from all the image compressors 300. In the above-described exemplary case where the scheduled transmission times are calculated based on the maximum expected period among the calculated expected compression periods, data awaiting transmission may be accumulated in the image compressors 300 after elapse of a certain period from the activation. Such accumulated data awaiting transmission can be eliminated by calculation of scheduled transmission times using a pre-trained model. The machine learning described above is executed by the engineering unit 500.

The engineering unit 500 includes a learning data acquirer 501 that acquires leaming data, a model generator 502 that generates a pre-trained model inferring a compression period from the learning data, and a pre-trained model retainer 503 that retains the pre-trained model.

For example, the learning data acquirer 501 acquires, as learning data, information on the performance of the image compressors 300, information on compression by the image compressors 300, information on inspection images, and information on compression periods required by the image compressors 300 for compression of the inspection images. The information on compression by the image compressors 300 indicates a compression procedure containing parameters and a compression ratio, for example. The information on inspection images indicates data sizes of the inspection images, for example.

The model generator 502 generates a pre-trained model that infers a compression period required for compression of an inspection image from the information on the performance of the image compressors 300, the information on compression by the image compressors 300, and the information on inspection images. The model generator 502 then causes the generated pre-trained model to be stored into the pre-trained model retainer 503. The model generator 502 may use a known learning algorithm, such as supervised learning algorithm, unsupervised learning algorithm, or reinforcement learning algorithm.

The calculator 202 acquires compression periods using the pre-trained model stored in the pre-trained model retainer 503, and defines the acquired compression periods as expected compression periods of the image compressors 300. The calculator 202 then determines scheduled transmission times on the basis of the expected compression periods.

The allocator 201 allocates inspection images accompanying information on scheduled transmission times to the image compressors 300, regardless of the load statuses of the image compressors 300. The compression manager 200 transmits the inspection images accompanying the information on scheduled transmission times, to the image compressors 300 to which the allocator 201 allocates the inspection images.

Each of the image compressors 300 compresses the inspection image received from the compression manager 200, refers to the time synchronized by the synchronizer 301 after completion of compression of the inspection image, and transmits the compressed inspection image to the storage 400 at the scheduled transmission time indicated by the information added to the inspection image. The storage 400 stores the compressed inspection images in the order of reception.

In the case of an additional period from the completion of compression until the scheduled transmission time, each of the image compressors 300 may compress inspection images stocked in the list of inspection images awaiting compression, In a method for transmitting compressed inspection images, for example, the image compressor 300 refer to the time while compressing stocked inspection images, and temporarily halt the compression and transmit the compressed inspection images at the scheduled transmission times. Alternatively, the image compressor 300 may transmit a compressed inspection image in response to interrupt processing at the scheduled transmission time.

Each of the image compressors 300 thus transmits a compressed inspection image at the scheduled transmission time, but may fail to transmit the compressed inspection image at the scheduled transmission time in some cases. Such a failure in transmission at the calculated scheduled transmission time may fail in storage in the chronological order. This situation requires recalculation of scheduled transmission times and reallocation of inspection images.

The image compressor 300 that has failed in transmission at the scheduled transmission time temporarily stops the transmission, and notifies the compression manager 200 of occurrence of a failure in transmission at the scheduled transmission time. The compression manager 200 notified of the failure instructs all the image compressors 300 to stop the transmission. The calculator 202 then recalculates scheduled transmission times, for all the inspection images corresponding to the compressed inspection images scheduled to be transmitted from the image compressors 300 to the storage 400. Specifically, the calculator 202 recalculates, on the basis of the recent progress of the compression, an expected compression period for the inspection image corresponding to the compressed inspection image that has failed to be transmitted at the scheduled transmission time. The calculator 202 then recalculates scheduled transmission times for all the inspection images not stored in the storage 400, in view of the recalculated expected compression period and the period of stopping the transmission. If the failure in transmission at the scheduled transmission time is caused by not the inspection image but a factor, such as performance of the image compressor 300, compression procedure, or compression ratio, the calculator 202 will possibly calculate an inappropriate scheduled transmission time again, and thus revises the procedure of calculating scheduled transmission times.

After completion of recalculation of scheduled transmission times by the calculator 202, the compression manager 200 notifies the image compressors 300 of the recalculated scheduled transmission times, and instructs all the image compressors 300 to restart the transmission. The image compressors 300 refrain from transmitting until they receive the instruction, but continue compressing inspection images.

After being instructed by the compression manager 200 to stop the transmission, the image compressor 300 may fail to immediately stop the transmission and transmit compressed inspection images to the storage 400 in an order different from the chronological order. In this case, the storage 400 refers to the chronological information added to the inspection image by the image acquirer 100 and added to the compressed inspection image by the image compressor 300, and does not store compressed inspection images received in the order different from the chronological order. After transmitting the compressed inspection images, the image compressors 300 retain the compressed inspection images until confirmation of successful storage of the compressed inspection images into the storage 400.

Specifically, the storage 400 determines whether the compressed inspection images have been received in the chronological order on the basis of the chronological information added to the compressed inspection images. When determining that the compressed inspection images have not been received in the chronological order, the storage 400 notifies the image compressor 300 that has transmitted the compressed inspection images of the deviation of the order of transmission from the chronological order. The image compressor 300 then notifies the compression manager 200 of the deviation of the order of transmission from the chronological order. The calculator 202 of the compression manager 200 recalculates scheduled transmission times of the compressed inspection images not stored in the storages 400, and notifies the image compressors 300 of the recalculated scheduled transmission times. When the image compressors 300 successfully transmit the compressed inspection images at the recalculated scheduled transmission times and the storage 400 stores the compressed inspection images in the chronological order, the image compressors 300 that have transmitted the compressed inspection images are notified of the completion of storage. The image compressors 300 refer to a notification of the completion of storage and then delete the compressed inspection images that have been stored.

In another case, the image compressor 300 may fail in transmission at the scheduled transmission time due to a malfunction thereof. Such a malfunctioning image compressor 300 may be excluded from the allocation destinations. When the compression manager 200 is notified by the image compressor 300 of the failure in transmission at the scheduled transmission time, the compression manager 200 receives the inspection images and the compressed inspection images allocated to the image compressor 300 that has output the notification, from the image compressor 300 that has output the notification. After recalculation of scheduled transmission times by the calculator 202, the allocator 201 excludes the image compressor 300 that has output the notification from the allocation destinations, and reallocates the inspection images and the compressed inspection images received from the image compressor 300 that has output the notification, to another image compressor 300. The compression manager 200 then transmits the inspection images and the compressed inspection images to the image compressor 300 to which the images are newly allocated.

The reallocated inspection images and compressed inspection images may be transmitted to another image compressor 300 not via the compression manager 200. In this case, the image compressors 300 are connected so as to communicate with each other. The retiring image compressor 300 receives results of reallocation by the allocator 201 from the compression manager 200, and transmits the inspection images and the compressed inspection images retained by the retiring image compressor 300 to another image compressor 300 on the basis of the results of reallocation. Alternatively, no reallocation may be performed for the inspection images and the compressed inspection images stocked in the retiring image compressor 300. In this case, the retiring image compressor 300 transmits all the stocked inspection images and compressed inspection images to the storage 400. The allocator 201 allocates an inspection image newly transmitted from the image acquirer 100 to any of the allocation destinations excluding the image compressor 300 that has failed in transmission at the scheduled transmission time.

Excluding the image compressor 300 from the allocation destinations may result in insufficient compression performance. Any insufficiency in compression performance is compensated by an additional image compressor 300 prepared in advance and connected as illustrated in Embodiment 1.

In general, compressed inspection images are not certainly transmitted from image compressors to a storage in the chronological order, and thus may be stored in an order different from the chronological order. In contrast, the system according to the embodiment aligns the times of transmission by the image compressors in the order identical to the chronological order of acquisition of the inspection images. The system thus allows the storage to receive compressed inspection images in the order identical to the chronological order of acquisition of the inspection images. The storage is thus only required to sequentially store the received compressed inspection images without realignment and achieves storage of the compressed inspection images in the chronological order. The system can thus reduce the processing load on the storage, which often creates a bottleneck.

### Embodiment 3

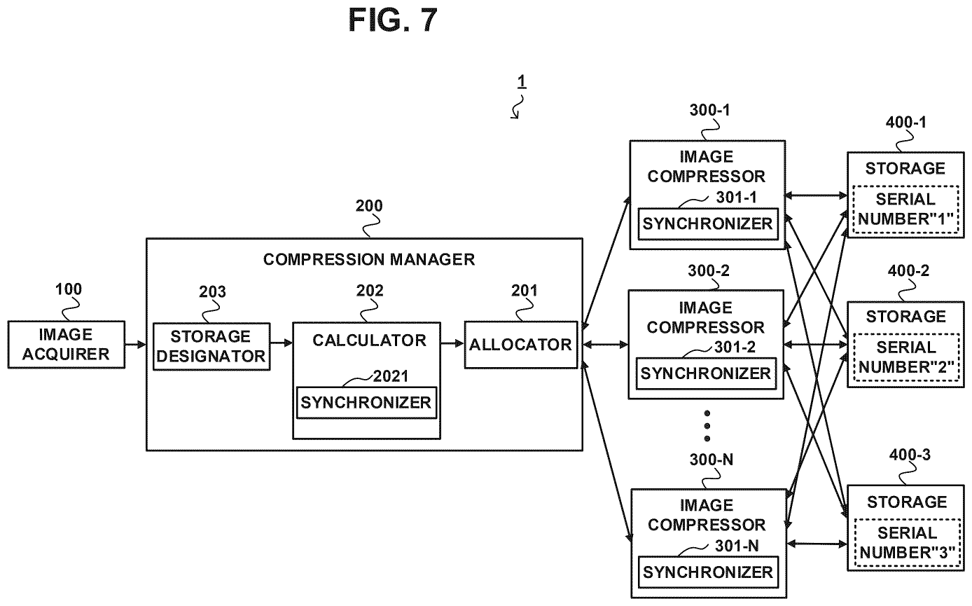

An inspection image storing system 1 according to Embodiment 3 includes multiple storages 400 and has a function of switching the storage destinations on the basis of the remaining capacities of the storages 400. The inspection image storing system 1 includes, as functional components, an image acquirer 100, a compression manager 200, image compressors 300-1 to 300-N, and storages 400-1 to 400-K (K is a natural number equal to or larger than 2). The storages 400-1 to 400-K are hereinafter collectively referred to as “storages 400” unless specifying a particular storage. FIG. 7 illustrates an exemplary configuration of the inspection image storing system 1 according to Embodiment 3. FIG. 7 illustrates exemplary three storages 400. The image acquirer 100 in Embodiment 3 has the same functions as that in Embodiment 2.

The individual storages 400 are provided with serial numbers. Information indicating correspondence between the storages 400 and the serial numbers is managed by the compression manager 200. When the storages 400 are connected to the image compressors 300, the image compressors 300 notify the compression manager 200 of establishment of connection of the storages 400. The compression manager 200 provides the storages 400 connected to the image compressors 300 with serial numbers in the order of notifications indicating establishment of connection of the storages 400 from the image compressors 300.

The following assumes an example in which no storage 400 is connected to the image compressors 300. When the first storage 400-1 is first connected to the image compressor 300-1, the image compressor 300-1 notifies the compression manager 200 of establishment of connection of the storage 400-1, and the compression manager 200 provides the storage 400-1 with a serial number “1”. When the second storage 400-2 is connected to the image compressor 300-2 subsequently to the storage 400-1, the image compressor 300-2 notifies the compression manager 200 of establishment of connection of the storage 400-2, and the compression manager 200 provides the storage 400-2 with a serial number “2”. When the third storage 400-3 is connected to the image compressor 300-3 subsequently to the storage 400-2, the image compressor 300-3 notifies the compression manager 200 of establishment of connection of the storage 400-3, and the compression manager 200 provides the storage 400-3 with a serial number “3”.

The compression manager 200 thus provides the storages 400 with serial numbers, in the order of notifications from the image compressors 300, that is, in the order of establishment of connection of the storages 400 to the image compressors 300. A serial number is provided to new storage 400 in response to every establishment of connection of the new storage 400 to the image compressors 300.

These serial numbers are used to indicate the order of use of the storages 400. That is, the order of use of the storages 400 is equal to the order of establishment of connection to the image compressors 300. The compression manager 200 records, as recently-used storage destination information, the serial number of the storage 400 that has most recently stored a compressed inspection image.

The compression manager 200 includes an allocator 201 that allocates inspection images to the image compressors 300, a calculator 202 that calculates scheduled transmission times of transmitting compressed inspection images from the image compressors 300 to the storages 400, and a storage designator 203 that designates storages to store the compressed inspection images.

Specifically, the storage designator 203 of the compression manager 200 designates, among the storages 400, a storage 400 expected to store a compressed inspection image, on the basis of the remaining capacities of the storages 400. For example, the storage designator 203 designates the storages 400 having remaining capacities higher than a predetermined threshold as the storage destinations, in the order of the serial numbers. The predetermined threshold is any value defined by the user of the inspection image storing system 1 for each storage 400. Information on the current remaining capacities of the storages 400 is notified by the storages 400, as is described below. The information on the remaining capacities of the storages 400 is managed by the compression manager 200. When the compression manager 200 receives an inspection image from the image acquirer 100, the storage designator 203 designates the storage 400 to store a compressed inspection image corresponding to the received inspection image, on the basis of the information on the remaining capacities of the storages 400 and the recently-used storage destination information. The storage designator 203 then provides the inspection image with the serial number of the designated storage 400.

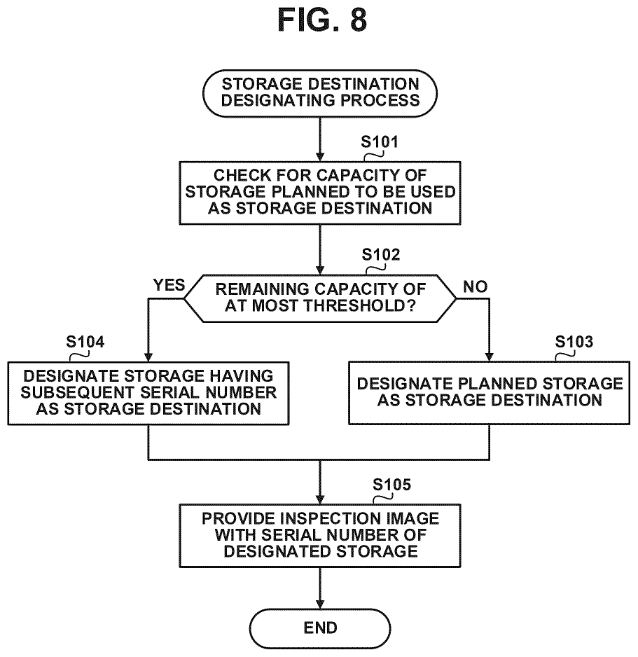

FIG. 8 is a flowchart illustrating a storage destination designating process executed by the storage designator 203. The storage destination designating process illustrated in FIG. 8 is executed in response to every reception of an inspection image by the compression manager 200 from the image acquirer 100.

The storage designator 203 checks for the remaining capacity of the storage 400 planned to store the received inspection image (Step S101).

The description assumes an example in which the compression manager 200 receives an inspection image 11 from the image acquirer 100, and has recorded the recently-used storage destination information indicating the serial number “1” of the storage 400-1. In this example, the storage designator 203 identifies the storage 400-2 having the serial number “2” as the storage 400 planned to store the inspection image 11, and refers to the information on the remaining capacities of the storages 400 managed by the compression manager 200 to check for the remaining capacity of the storage 400-2.

The storage designator 203 then determines whether the remaining capacity of the storage 400 planned to store the inspection image is at most the predetermined threshold (Step S102). When determining that the remaining capacity of the storage 400 planned to store the inspection image is not at most the predetermined threshold (Step S102; NO), the storage designator 203 designates the planned storage 400 as the storage destination (Step S103), and provides the inspection image with the serial number of the designated storage 400 (Step S105). In contrast, when determining that the remaining capacity of the storage 400 planned to store the inspection image is at most the predetermined threshold (Step S102; YES), the storage designator 203 designates, as the storage destination, another storage 400 having the serial number subsequent to the serial number of the planned storage 400 (Step S104), and provides the inspection image with the serial number of the designated storage 400 (Step S105). After Step S105, the storage designator 203 terminates the storage destination designating process illustrated in FIG. 8.

For example, when the storage designator 203 determines that the remaining capacity of the storage 400-2 is not the predetermined threshold or lower, the storage designator 203 designates the storage 400-2 as the storage destination, and provides the inspection image 11 with the serial number “2” of the storage 400-2. In contrast, when the storage designator 203 determines that the remaining capacity of the storage 400-2 is the predetermined threshold or lower, the storage designator 203 designates, as the storage destination, the storage 400-3 having the serial number “3” subsequent to the serial number “2”, and provides the inspection image 11 with the serial number “3” of the storage 400-3. After provision of the serial number, the storage designator 203 terminates the storage destination designating process.

The calculator 202 then calculates a scheduled transmission time of transmitting each compressed inspection image from the image compressor 300 to the storage 400, and provides the inspection image with information on the scheduled transmission time. The allocator 201 then determines the image compressor 300 to compress the inspection image. The compression manager 200 transmits the inspection image accompanying the serial number and the information on the scheduled transmission time, to the image compressor 300 determined by the allocator 201. After transmitting the inspection image, the compression manager 200 records the serial number provided to the transmitted inspection image in the form of the recently-used storage destination information.

The image compressor 300, which retains the information indicating correspondence between the serial numbers and the storages 400, identifies the storage 400 corresponding to the serial number provided to the received inspection image with reference to this correspondence information. The image compressor 300 transmits the compressed inspection image to the identified storage 400 at the scheduled transmission time.

The storage 400 receives the compressed inspection image from the image compressor 300 and stores the compressed inspection image. The storage 400 then notifies the compression manager 200 of the remaining capacity of the storage 400, via the image compressor 300 that has transmitted the stored compressed inspection image. This notification of the remaining capacity by the storage 400 is executed in response to every storage of a compressed inspection image received from the image compressor 300 into the storage 400.

For example, when the storage 400-2 receives the compressed inspection image 11 from the image compressor 300-1, the storage 400-2 stores the compressed inspection image 11, and notifies the image compressor 300-1 that has transmitted the compressed inspection image 11 of the remaining capacity of the storage 400-2. When being notified of the remaining capacity, the image compressor 300-1 notifies the compression manager 200 of the remaining capacity of the storage 400-2. The storages 400 thus provide notifications of their remaining capacities.

The storages 400 are hot-swappable after completion of storage of the compressed inspection images transmitted from the image compressors 300.

The following focuses on an example in which the storage 400-2 has a remaining capacity of the predetermined threshold or lower and the storage 400-3 completes the storage of the compressed inspection image 11 that was planned to be stored into the storage 400-2. In this example, the storage 400-2 can be replaced with a new storage 400-4 through hot-swapping. When the storage 400-4 is connected to the image compressors 300, the compression manager 200 provides the storage 400-4 with the serial number “4”. The storages 400 after this hot-swapping are used in the order of the storage 400-1 having the serial number “1”, the storage 400-3 having the serial number “3”, and the storage 400-4 having the serial number “4”.

The storage designator 203 may output a signal regarding the remaining capacities of the storages 400. For example, the storage designator 203 may output an error signal when all the storages 400 have remaining capacities of the predetermined threshold or lower. For another example, the storage designator 203 may output an alarm signal when only one of the storages 400 has a remaining capacity higher than the predetermined threshold.

The compressed inspection image may fail to be stored, because the compressed inspection image exceeds the capacity limit of the storage 400, having a remaining capacity of the predetermined threshold or lower, before the storage designator 203 switches the storage destinations from the storage 400 having a remaining capacity of the predetermined threshold or lower to another storage 400. The storage 400, when failing to store the compressed inspection image, notifies the image compressor 300 that has transmitted the compressed inspection image of a storage failure. The image compressor 300 notified of the storage failure notifies the compression manager 200 of the storage failure. The image compressor 300 retains the compressed inspection image that has been transmitted to the storage 400 until being notified of successful storage by the storage 400. The compression manager 200 notified of the storage failure instructs all the image compressors 300 to stop the transmission of the compressed inspection images to the storages 400. When the compression manager 200 is notified of the storage failure, the storage designator 203 switches the storage destination for the compressed inspection image that has failed in storage. The storage designator 203 also switches the storage destination for any compressed inspection image scheduled to be transmitted after the compressed inspection image that has failed in storage and scheduled to be stored into the storage 400 that has failed to store the compressed inspection image. The calculator 202 then recalculates scheduled transmission times for all the inspection images scheduled to be transmitted to the image compressors 300.

The compression manager 200 then notifies all the image compressors 300 of the serial number of the storage 400 being the switched storage destination and the recalculated scheduled transmission times, and instructs all the image compressors 300 to restart the transmission.

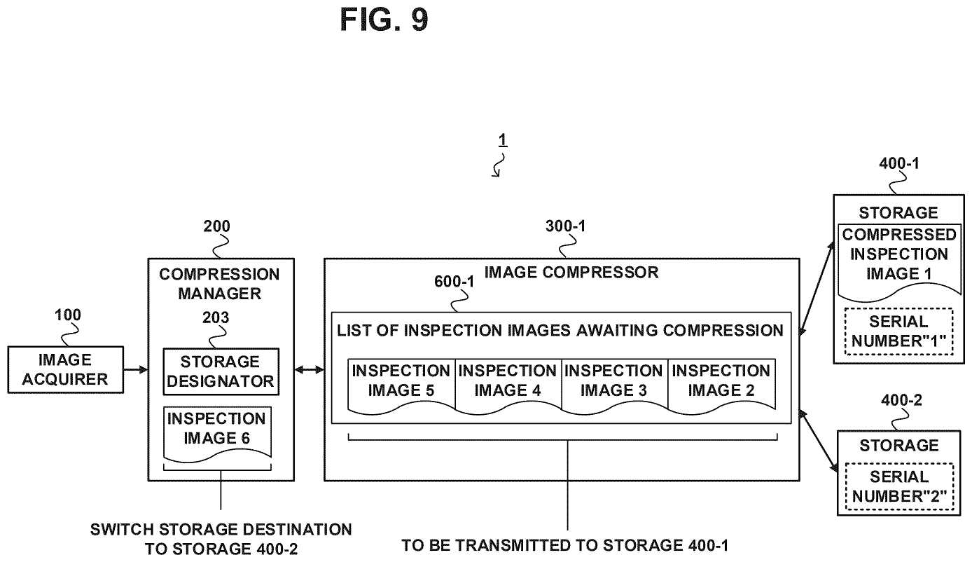

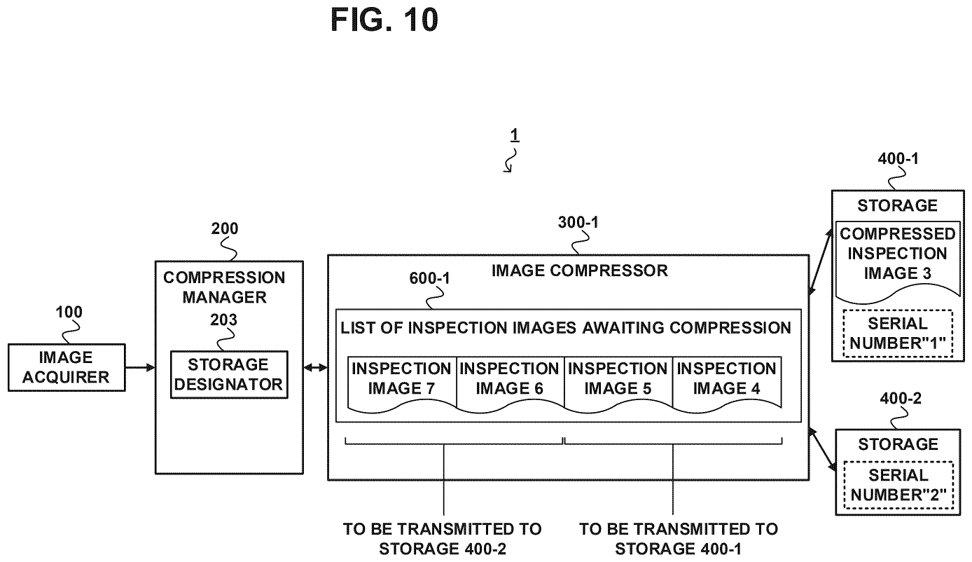

The following describes exemplary switching of a storage destination with reference to FIGS. 9 and 10. FIGS. 9 and 10 illustrate the inspection image storing system 1 including a single image compressor 300 and two storages 400, in order to simplify the description. FIGS. 9 and 10 do not illustrate the allocator 201 or the calculator 202 of the compression manager 200. FIG. 9 assumes an example in which the transmission of inspection images 1 to 5 to the image compressor 300-1 is followed by establishment of connection of the storage 400-2 to the image compressor 300-1 and provision of the serial number “2” to the storage 400-2.

In the example in FIG. 9, the remaining capacity of the storage 400-1 decreases to the predetermined threshold or lower at the time of storage of the compressed inspection image 1 generated by compressing the inspection image 1 into the storage 400-1. The storage 400-1 stores the compressed inspection image 1, and then notifies the compression manager 200 of the remaining capacity of the storage 400-1 via the image compressor 300-1. When determining that the remaining capacity of the storage 400-1 is the predetermined threshold or lower, the storage designator 203 designates the storage 400-2 as the storage destination for an inspection image 6 newly received by the compression manager 200. In contrast, the inspection images 2 to 5 have already been transmitted to the image compressor 300-1, and the compressed inspection images 2 to 5 generated by compressing the inspection images 2 to 5 are scheduled to be transmitted to the storage 400-1. If the compressed inspection images 2 to 5 are transmitted to the storage 400-1 in accordance with the transmission schedule, the compressed inspection images 2 to 5 may exceed the capacity limit of the storage 400-1 and fail in storage.

FIG. 10 illustrates an exemplary storage failure of the compressed inspection image 3 due to no capacity of the storage 400-1 during storage of the compressed inspection image 3 into the storage 400-1. In this case, the storage 400-1 notifies the compression manager 200 of a storage failure of the compressed inspection image 3, via the image compressor 300-1. The compression manager 200 notified of the storage failure instructs the image compressor 300-1 to stop the transmission. The image compressor 300-1 stops the transmission and executes only the compression. The storage designator 203 then switches the storage destination for the compressed inspection image 3 to the storage 400-2, and also switches, to the storage 400-2, the storage destination for the compressed inspection images 4 and 5 corresponding to the inspection images 4 and 5 scheduled to be subsequently transmitted. The calculator 202 recalculates scheduled transmission times of the compressed inspection images 4 to 7 corresponding to the inspection images 4 to 7. The compression manager 200 then notifies the image compressor 300-1 of the serial number “2” of the storage 400-2 being the switched storage destination and the recalculated scheduled transmission times, and instructs the image compressor 300-1 to restart the transmission. The image compressor 300-1 restarts the transmission, and sequentially transmits the retained compressed inspection images to the storage 400-2 in the order from the compressed inspection image 3. This series of steps in the case of a storage failure due to exceedance of the capacity limit of the storage 400 is identical to that in the case of a storage failure due to any malfunction of the storage 400.

The capacities of the storages may be insufficient in the case of storage of a large number of inspection images during long-term operations of the production facilities. The system according to the embodiment includes multiple storages and can switch the storage destination for compressed inspection images on the basis of the remaining capacities of the storages, thereby ensuring sufficient storages for inspection images. Any of the storages can be replaced with a new storage through hot-swapping, after completion of storage of compressed inspection images. This feature can improve the scalability of storage capacity without inhibiting long-term operations of the production facilities.

### Embodiment 4

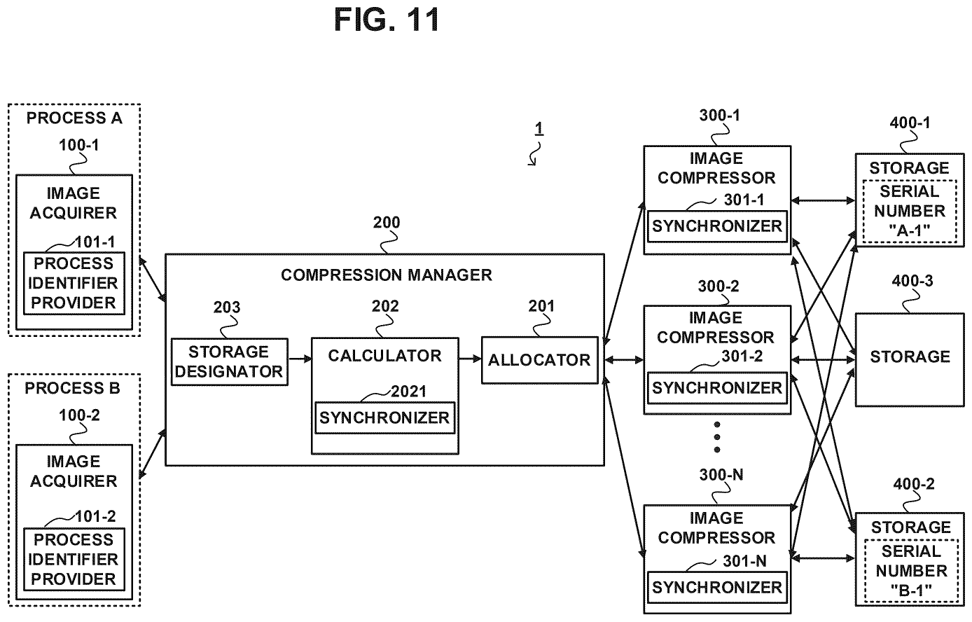

An inspection image storing system 1 according to Embodiment 4 has a function of switching storage destinations for inspection images in multiple processes, depending on the processes. The inspection image storing system 1 includes, as functional components, image acquirers 100-1 to 100-L (L is a natural number equal to or larger than 2), a compression manager 200, image compressors 300-1 to 300-N, and storages 400-1 to 400-K. The image acquirers 100-1 to 100-L respectively include process identifier providers 101-1 to 101-L. The image acquirers 100-1 to 100-L are hereinafter collectively referred to as “image acquirers 100” unless specifying a particular image acquirer. The process identifier providers 101-1 to 101-L are hereinafter collectively referred to as “process identifier providers 101” unless specifying a particular process identifier provider. FIG. 11 illustrates an exemplary configuration of the inspection image storing system 1 according to Embodiment 4. FIG. 11 illustrates two image acquirers 100 and three storages 400 for storage of inspection images in two processes.

The image acquirers 100 in Embodiment 4 are provided for the individual processes and acquire inspection images in the individual processes. Each of the image acquirers 100 includes the process identifier provider 101 that provides the acquired inspection images with a process identifier for identifying the process. The process identifier provider 101 provides an inspection image with the process identifier in response to every acquisition of the inspection image by the image acquirer 100. The process corresponds to a part of the production line in a manufacturing environment. A typical example of the process is a process of examining the processed surfaces of works. In this example, in response to capturing of an inspection image in the process of examining the processed surfaces of works by the image acquirer 100, the process identifier provider 101 provides the captured inspection image with the process identifier indicating this examination process.

Specifically, when the image acquirer 100-1 captures an inspection image A1 in a process A, the process identifier provider 101-1 provides the captured inspection image A1 with the process identifier “A”. Then, when the image acquirer 100-1 captures an inspection image A2 in the process A, the process identifier provider 101-1 provides the captured inspection image A2 with the process identifier “A”. Also, when the image acquirer 100-2 captures an inspection image B1 in a process B, the process identifier provider 101-2 provides the captured inspection image B1 with the process identifier “B”. Then, when the image acquirer 100-2 captures an inspection image B2 in the process B, the process identifier provider 101-2 provides the captured inspection image B2 with the process identifier “B”.

The storages 400 in Embodiment 4 are associated with the process identifiers. Specifically, the storages 400 are provided with the serial numbers associated with the process identifiers. The order of use of the storages 400 is determined so as to be identical to the order of establishment of connection to the image compressors 300. FIG. 11 assumes an example in which the storages 400-1, 400-2, and 400-3 are connected to the image compressors 300 in this sequence. After the activation of the inspection image storing system 1, the image acquirer 100-1 acquires the inspection image A1 in the process A and first transmits the inspection image A1 to the compression manager 200 in this example. The compression manager 200 then determines he storage 400-1 ranked as the first in the order of use, as the storage 400 dedicated to the process A, and provides the storage 400-1 with a serial number “A-1” associated with the process identifier “A”. The image acquirer 100-2 then acquires the inspection image B1 in the process B and transmits the inspection image B1 to the compression manager 200 subsequently to the image acquirer 100-1 in this example. The compression manager 200 then determines the storage 400-2 ranked as the second in the order of use, as the storage 400 dedicated to the process B, and provides the storage 400-2 with a serial number “B-1” associated with the process identifier “B”. The storage 400-3 has been determined to be the third in the order of use, but is unused and the process in which the storage 400-3 is used has not been determined. The compression manager 200 records the recently-used storage destination information indicating the serial number of the most recently used storage 400 for each process.

The storage designator 203 of the compression manager 200 designates the storage 400 to store a compressed inspection image from among the storages 400, on the basis of the process identifier provided to the inspection image. For example, the storage designator 203 designates the storage 400 to store the compressed inspection image, on the basis of the process identifier provided to the inspection image and the remaining capacity of the storage 400.

Specifically, when the compression manager 200 receives an inspection image from any of the image acquirers 100, the storage designator 203 checks for the remaining capacity of the storage 400 having the serial number associated with the process identifier provided to the inspection image. When the remaining capacity of the storage 400 exceeds a predetermined threshold, the storage designator 203 designates, as the storage destination, the storage 400 having the serial number associated with the process identifier provided to the inspection image, and provides the inspection image with the serial number of the designated storage 400.

For example, when the compression manager 200 receives the inspection image A2 provided with the process identifier “A” from the image acquirer 100-1 for the process A, the storage designator 203 checks for the remaining capacity of the storage 400-1 having the serial number “A-1” associated with the process identifier “A”. When the remaining capacity of the storage 400-1 exceeds the predetermined threshold, the storage designator 203 provides the inspection image A2 with the serial number “A-1”, and transmits this inspection image A2 to the image compressor 300 to which the allocator 201 allocates the inspection image A2.

In contrast, when the remaining capacity of the storage 400 is the predetermined threshold or lower, the storage designator 203 designates an unused storage 400 as the storage destination.

The following describes an exemplary switching of a storage destination with reference to FIG. 11. In the example in FIG. 11, the remaining capacity of the storage 400-1 is the predetermined threshold or lower. When the compression manager 200 receives an inspection image A3 provided with the process identifier “A” from the image acquirer 100-1 for the process A, the storage designator 203 determines that the remaining capacity of the storage 400-1 used as the storage dedicated to the process A is the predetermined threshold or lower. The storage designator 203 then designates the unused storage 400-3 ranked as the third in the order of use, as a new storage dedicated to the process A, and provides the storage 400-3 with a serial number “A-2” associated with the process identifier “A”. The compression manager 200 then provides the serial number “A-2” to the inspection image A3 received from the image acquirer 100-1 for the process A, and transmits the inspection image A3 to the image compressor 300 to which the allocator 201 allocates the inspection image A3.

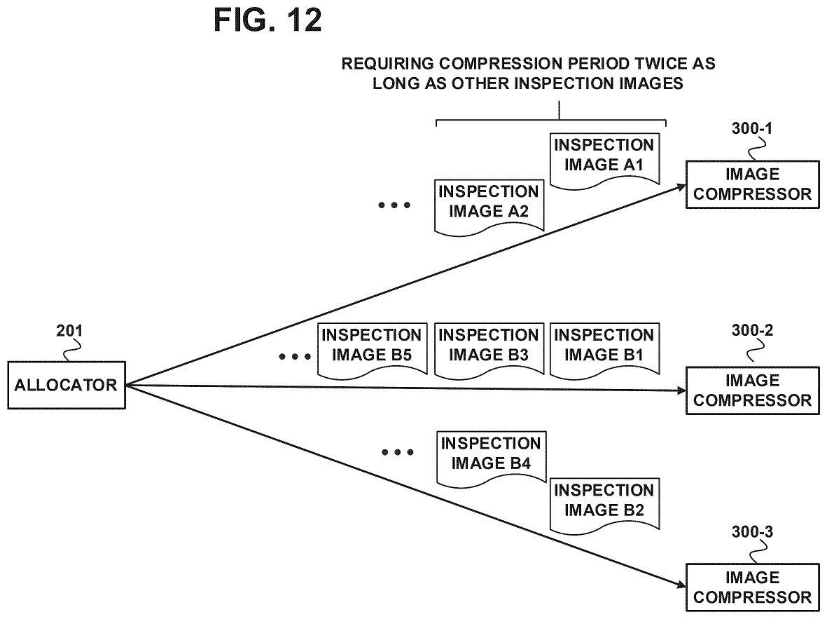

The allocator 201 may allocate inspection images to the image processors 300, in view of the processing loads of compressing inspection images in the individual processes. When the processing includes the multiple processes, data sizes of inspection images, compression format, and compression ratio, and the like may be different for the individual processes. The processes thus have different compression processing loads per single image. These compression processing loads may be referenced to change a distribution of the number of inspection images. FIG. 12 illustrates another exemplary allocation to change a distribution of the number of inspection images in accordance with the compression processing loads. The example in FIG. 12 assumes the system including three image compressors 300. The image acquirer 100-1 acquires inspection images A1 and A2, and the image acquirer 100-2 acquires inspection images B1 to B5, in the order of the inspection image A1, the inspection images B1 to B4, the inspection image A2, the inspection image B5, and so on. This example assumes that the compression of the inspection image A1 or A2 needs a period twice as long as the compression of any of the other inspection images B1 to B5. The allocator 201 in this example, after the allocation of the inspection image B2, allocates the inspection image B3 to the image compressor 300-2, and the inspection image B4 to the image compressor 300-3. This allocation procedure can equalize the times required for compression. When the image compressor 300-1 has sufficient performance and, at the allocation of the inspection image B3, has already completed the compression of the inspection image A1 and entered a waiting state, the allocator 201 may allocate the inspection image B3 to the image compressor 300-1.

In general, storage of inspection images in multiple processes requires preparation and establishment of inspection image storing systems for the individual processes. If the image compressors are dedicated to the individual processes, resources cannot be used efficiently. The system according to the embodiment has a function to switch the storage destinations depending on the processes, and thus allow a single inspection image storing system to store inspection images in multiple processes. The system can thus reduce workloads for establishment of additional systems and effectively share the functions of compressing inspection images.

### Modifications

The above-described embodiments of the present disclosure may be varied and revised into various modifications.

Although the inspection image storing system 2 according to Embodiment 1 includes the engineering unit 500, this configuration is a mere example. The inspection image storing system 1 may exclude the engineering unit 500. Although the image acquirer 100, the compression manager 200, the image compressors 300, the storage 400, and the engineering unit 500 are implemented on separate information processing devices in Embodiment 1, this configuration is a mere example. The engineering unit 500 may be implemented on the same information processing device as the compression manager 200.

Although the inspection image storing system 1 according to Embodiment 2 illustrated in FIG. 6 includes a single storage 400, the inspection image storing system 1 may include multiple storages 400. The multiple storages 400 are capable of storage in the chronological order without an additional function of order alignment in each storage 400.

The engineering unit 500 in Embodiment 2 may suggest the number calculated based on Expression 1, as in Embodiment 1, as the number of image compressors 300 required in the inspection image storing system 1.

Although the compression manager 200 in Embodiments 3 and 4 includes the calculator 202, the compression manager 200 may exclude the calculator 202.

Although FIG. 11 illustrates a single storage 400 dedicated to each process in Embodiment 4, this configuration is a mere example. Multiple storages 400 may be assigned to a single process. For example, the compression manager 200 may assign the storages 400-1 and 400-3 as storages 400 dedicated to the process A at the activation of the inspection image storing system 1.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can provide an inspection image storing system and a method of storing inspection images that can ensure scalability of compression performance for inspection images.

### REFERENCE SIGNS LIST

1 Inspection image storing system
10 Information processing device
11 Processor
12 Main storage
13 Auxiliary storage
14 Communicator
15 Inputter
16 Outputter
17 Bus
100, 100-1, 100-2 Image acquirer
101-1, 101-2 Process identifier provider
200 Compression manager
201 Allocator
202 Calculator
203 Storage designator
2021, 301, 301-1, . . . , 301-N Synchronizer
300, 300-1, . . . , 300-N Image compressor
400, 400-1, 400-2, 400-3 Storage
500 Engineering unit
501 Learning data acquirer
502 Model generator
503 Pre-trained model retainer
600-1 List of inspection images awaiting compression

1. An inspection image storing system, comprising:
at least one first processing circuitry to acquire inspection images;
a plurality of second processing circuitries to compress the inspection images;
third processing circuitry to
select second processing circuitry expected to compress an inspection image from the plurality of second processing circuitries,
allocate the inspection image to the selected second processing circuitry, and
transmit the inspection image to the second processing circuitry to which the inspection image is allocated; and
at least one storage to store compressed inspection images generated by compressing the inspection images by the plurality of second processing circuitries, wherein
the plurality of second processing circuitries is connected to the third processing circuitry and the at least one storage via a communication network, and compresses the inspection images transmitted by the third processing circuitry.

2. The inspection image storing system according to claim 1, wherein
the third processing circuitry calculates a scheduled transmission time when each of the plurality of second processing circuitries transmits the compressed inspection image to the at least one storage, and
each of the plurality of second processing circuitries transmits the compressed inspection image to the at least one storage at the scheduled transmission time calculated by the third processing circuitry.

3. The inspection image storing system according to claim 1, wherein the third processing circuitry
acquires information indicating load statuses of the plurality of second processing circuitries, and
selects, based on the load statuses indicated by the acquired information, second processing circuitry expected to compress an inspection image, and allocates the inspection image to the selected second processing circuitry.

4. The inspection image storing system according to claim 2, wherein the third processing circuitry acquires a compression period using a pre-trained model, and determines the scheduled transmission time based on the acquired compression period, the compression period being required by each of the plurality of second processing circuitries for compression of an inspection image, the pre-trained model inferring the compression period from information on performance of the second processing circuitry, information on compression by the second processing circuitry, and information on the inspection image.

5. The inspection image storing system according to claim 1, wherein
the at least one storage includes a plurality of the storages, and
the third processing circuitry designates, based on remaining capacities of the plurality of storages, a storage expected to store the compressed inspection image from among the plurality of storages.

6. The inspection image storing system according to claim 1, wherein
the at least one first processing circuitry includes a plurality of the first processing circuitries provided for individual processes to acquire inspection images in the individual processes,
the at least one storage includes a plurality of the storages,
the plurality of first processing circuitries provides the acquired inspection images with process identifiers for identifying the processes,
the process identifiers are associated with the plurality of storages, and
the third processing circuitry designates, based on the process identifiers provided to the inspection images, a storage expected to store the compressed inspection image from among the plurality of storages.

7. A method of storing inspection images executed by an inspection image storing system, the method comprising:
selecting, by third processing circuitry, second processing circuitry expected to compress an inspection image from a plurality of second processing circuitries, allocating the inspection image to the selected second processing circuitry, and transmitting the inspection image to the second processing circuitry to which the inspection image is allocated, the inspection image being acquired by at least one first processing circuitry;
compressing, by the second processing circuitry, the inspection image transmitted by the third processing circuitry, the inspection image being allocated to the second processing circuitry by the third processing circuitry among the plurality of second processing circuitries; and
storing, by at least one storage, a compressed inspection image generated by compressing the inspection image by the second processing circuitry, wherein
the plurality of second processing circuitries is connected to the third processing circuitry and the at least one storage via a communication network in the inspection image storing system.

8. The inspection image storing system according to claim 2, wherein the third processing circuitry
acquires information indicating load statuses of the plurality of second processing circuitries, and
selects, based on the load statuses indicated by the acquired information, second processing circuitry expected to compress an inspection image, and allocates the inspection image to the selected second processing circuitry.

9. The inspection image storing system according to claim 2, wherein
the at least one storage includes a plurality of the storages, and
the third processing circuitry designates, based on remaining capacities of the plurality of storages, a storage expected to store the compressed inspection image from among the plurality of storages.

10. The inspection image storing system according to claim 3, wherein
the at least one storage includes a plurality of the storages, and
the third processing circuitry designates, based on remaining capacities of the plurality of storages, a storage expected to store the compressed inspection image from among the plurality of storages.

11. The inspection image storing system according to claim 4, wherein
the at least one storage includes a plurality of the storages, and
the third processing circuitry designates, based on remaining capacities of the plurality of storages, a storage expected to store the compressed inspection image from among the plurality of storages.

12. The inspection image storing system according to claim 2, wherein
the at least one first processing circuitry includes a plurality of the first processing circuitries provided for individual processes to acquire inspection images in the individual processes,
the at least one storage includes a plurality of the storages,
the plurality of first processing circuitries provides the acquired inspection images with process identifiers for identifying the processes,
the process identifiers are associated with the plurality of storages, and
the third processing circuitry designates, based on the process identifiers provided to the inspection images, a storage expected to store the compressed inspection image from among the plurality of storages.

13. The inspection image storing system according to claim 3, wherein
the at least one first processing circuitry includes a plurality of the first processing circuitries provided for individual processes to acquire inspection images in the individual processes,
the at least one storage includes a plurality of the storages,
the plurality of first processing circuitries provides the acquired inspection images with process identifiers for identifying the processes,
the process identifiers are associated with the plurality of storages, and
the third processing circuitry designates, based on the process identifiers provided to the inspection images, a storage expected to store the compressed inspection image from among the plurality of storages.

14. The inspection image storing system according to claim 4, wherein
the at least one first processing circuitry includes a plurality of the first processing circuitries provided for individual processes to acquire inspection images in the individual processes,
the at least one storage includes a plurality of the storages,
the plurality of first processing circuitries provides the acquired inspection images with process identifiers for identifying the processes,
the process identifiers are associated with the plurality of storages, and
the third processing circuitry designates, based on the process identifiers provided to the inspection images, a storage expected to store the compressed inspection image from among the plurality of storages.

15. The inspection image storing system according to claim 5, wherein
the at least one first processing circuitry includes a plurality of the first processing circuitries provided for individual processes to acquire inspection images in the individual processes,
the at least one storage includes a plurality of the storages,
the plurality of first processing circuitries provides the acquired inspection images with process identifiers for identifying the processes,
the process identifiers are associated with the plurality of storages, and
the third processing circuitry designates, based on the process identifiers provided to the inspection images, a storage expected to store the compressed inspection image from among the plurality of storages.
